(19) United States
(12) Patent Application Publication
(10) Pub. No.: US 2008/0288279 A1
(43) Pub. Date: Nov. 20, 2008

(54) REAL-TIME INTERACTIVE SURVEY SYSTEM AND METHOD

(76) Inventors: Terry L. Henley, Troy, OH (US); Chad Kouse, Kettering, OH (US)

Correspondence Address: A PATENT LAWYER CORP, PLC;R WILLIAM GRAHAM, 22 S ST CLAIR ST, DAYTON, OH, 45402, US

(21) Appl. No.: 11/748,032

(22) Filed: May 14, 2007

(51) Int. Cl. G06Q 10/00; G06F 19/00

(52) U.S. Cl. 705/2; 705/10

(57) ABSTRACT

A method and system of conducting surveys within a hospital includes the steps of (a) providing a phone or television at the hospital which is operably connected to a computer based device having survey software thereon for conducting a telephonic or television survey with the patient (b) conducting said telephone or television survey with a patient through the phone thereby gathering survey result data and (c) real-time transmitting said result data to an attendant within the hospital.

### FIELD OF INVENTION

This invention relates generally to a method and system for conducting surveys which are employed in medical the medical field to enhance management effectiveness. More specifically, the invention relates to a method and system for conducting a real-time interactive survey to enhance medical care and promote patient loyalty.

### BACKGROUND

Traditional survey approaches can be costly due to the criteria used in developing such surveys, such as supplies and survey provider rates. Several factors of quality, cost, and access must be evaluated simultaneously in order to assess how well and at what cost a hospital or doctor provides medical care. Current systems and methods of determining these factors are lacking and do not provide significantly useful information to the hospital manager.

A primary focus of a hospital administrator is maintaining a loyal patient (customer) base and increasing the number of new patients (customers). Maintaining loyal patients continually requires that the hospital administrator evaluate why such loyal patients decide to use its hospital instead of a competitor's. The question defines the equity of the hospital. Hospital administrators understand that loyalty is important to maintaining a successful hospital. Loyalty is a direct function of customer satisfaction and thus surveys are done in an effort to determine satisfaction and maintain loyalty.

Consider the choice of hospitals in a given geographic area. If customer-patients are satisfied, they will return for future treatments and recommend the hospital to their friends. Patient loyalty translates into continued business for the hospital. Their dissatisfaction means moving their business reducing the revenue of the hospital.

The equity of a hospital is in large part a function of loyalty and reputation provided by patients using its services. A hospital which develops substantial patient equity is more protected from competition or changes in the marketplace. Survey evaluation of such equity is desirable so that informed marketing and business decisions regarding the service can be made, particularly when surveys can be performed cost effectively.

Consumer view points as to medical care, particularly at hospitals, are commonly evaluated using a Press-Ganey survey which is known in the industry. A typical paradigm is to consider the choice of hospitals in a given geographic area and whether customer-patients are satisfied, based on their return for future treatments and/or recommend the facilities to their friends. Patient loyalty translates into continued business for the hospital. Dissatisfaction results in moving their business to the other competing facilities thereby reducing the revenue of the hospital. It is therefore imperative to maintain satisfied, loyal customers who will continue to use the hospital's services.

While current approaches have some value, there remains a need to improve the system and method of surveying patients in order to improve hospital management and patient care. The present invention accomplishes these goals.

### SUMMARY OF INVENTION

It is an object to improve surveys in the medical field.

It is another object to provide a real-time survey method and system.

It is also an object to improve patient psychological state of attitude.

It is an object to improve patient loyalty.

It is still another object to increase hospital business through patient referrals.

Yet another object of the invention is to provide a system and method that evaluates the quality, cost and access of treatment facilities and identify deficiencies thereby.

The present invention is intended to provide a useful way to ascertain results of survey information in real-time so that improvements in medical care can be made in the hospitals in both an immediate and long-term manner. For example, the instant invention provides for such results to be immediately used to view patient needs and desires and history and administer care as desired. By doing so, the hospital can gain favorable patient perceptions, which is likely to impart loyalty and induce recommendations leading to future customers.

Accordingly, the present invention is directed to a method of surveying patients (or potential customer) within a hospital. The method includes the steps of (a) providing a phone at the hospital which is operably connected to a computer based device having survey software thereon for conducting a telephonic survey with the patient, (b) conducting the telephone survey with the patient through the phone and (c) real-time transmitting results obtained through the telephone survey to an attendant within the hospital. In another embodiment, the method includes the steps of (a) providing a television at the hospital which is operably connected to a computer based device having survey software thereon for conducting a television survey with the patient, (b) conducting the television survey with the patient through the television and (c) real-time transmitting results obtained through the television survey to an attendant within the hospital. The method can also include the step of generating a real-time report. A further step can be dispatching a predetermined attendant in response to one or more survey responses.

The survey software can be equipped to prompt the patient through a series of topics and to indicate by predetermined numbers on the phone a level of satisfaction for the particular topic. Such topics can include medical care, nursing services, physician services, overall treatment, food, hospital amenities, admission process, room condition, cost, cleaning and janitorial service, etc. The survey software can be equipped to send a signal, e.g., through a network, to a particular attendant upon the patient providing a particular response during a survey, such as dissatisfaction with the food whereby an electronic message can be sent to the hospital administrator as well as the cook to address the issue. Further, survey software can be equipped to gather data quantifying quality, cost, and assess performance characteristics of each, display the quality, cost and assess performance characteristic simultaneously on a graph to indicate thereby strong and weak quality and cost and assess performance characteristics, and identify the strong and weak quality and cost and assess performance characteristics of each. A system employing the same is also provided.

These objects together with other objects, features and advantages of the invention will become more readily apparent from the following detailed description when taken in conjunction with the accompanying drawings wherein like elements are given like reference numerals throughout.

### DESCRIPTION OF THE DRAWINGS

FIG. 1 is a schematic of the present invention.

FIG. 2 is a screen shot depicting a monthly comparison of the department rank from year to year.

FIG. 3 depicts a daily completion report for surveys completed by patient.

FIG. 4 depicts a help desk report screen showing status of items.

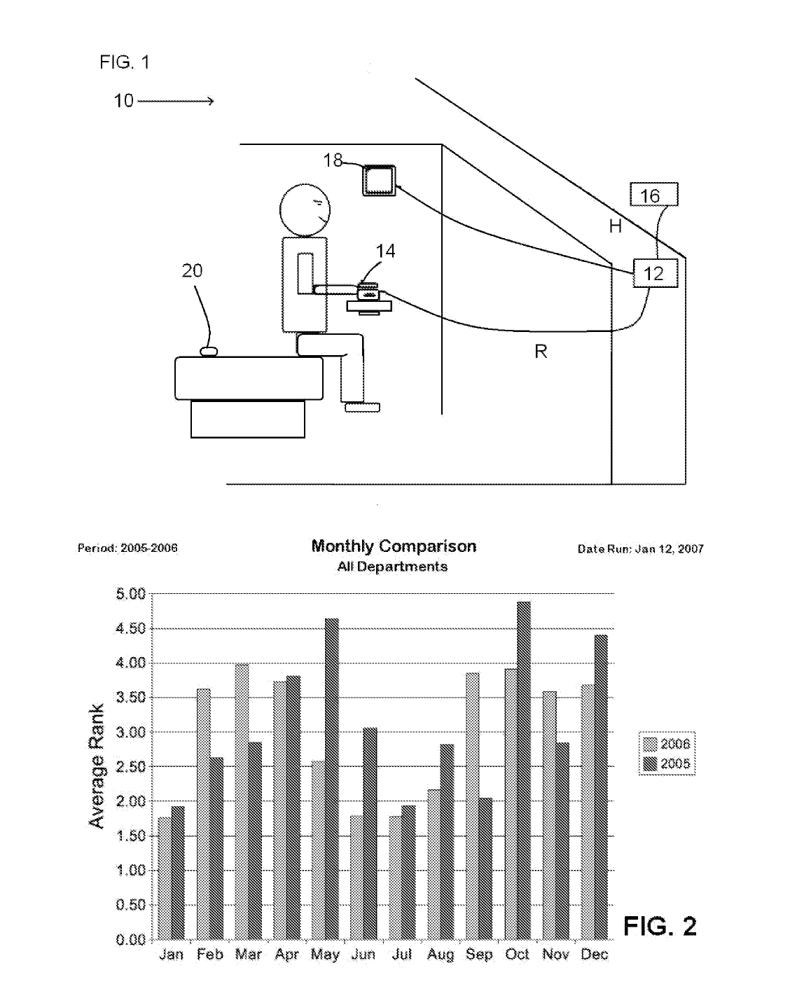

### DETAILED DESCRIPTION OF THE PREFERRED EMBODIMENT

The present invention is a process and system of modeling the factors of quality, cost, and access in such a manner as to provide a holistic description of the effectiveness of medical treatment data from a variety of computerized databases and incorporating patient perceptions of medical care through the use of surveys. This allows effectiveness of different groups of medical care facilities to be compared to each other. Deficiencies in performance are readily identified through this process, permitting goals and targets to be established that provide direction for medical administrators to enhance medical care at their treatment facilities.

Referring now to the present invention, the system and method for surveying patients (or potential customer) within a hospital is generally referred to by the numeral 10. The system 10 can preferably include a computer based device 12 which can be operably disposed in a hospital H or at a remote site. The computer based device 12 can be operably connected to a phone 14 which can be disposed in room R, such as a patient room, of the hospital H. The computer based device 12 can be equipped to communicate with the other computers 16 located local or remotely in order to transact and process information running standard operating system software such as Windows, Linux, or Unix.

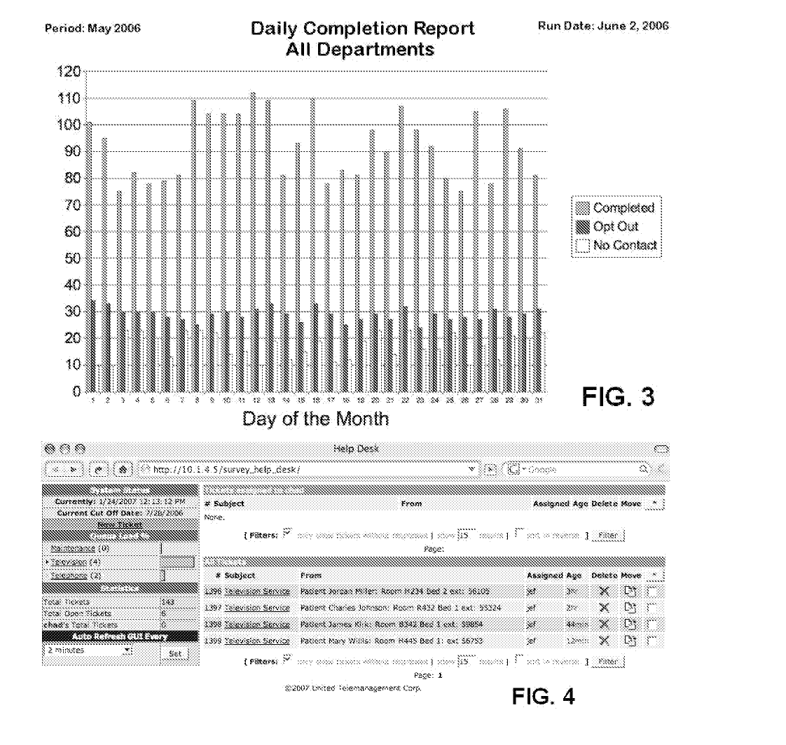

It is understood that computer based device 12 can be equipped with conventional hardware, such as processor, memory, power source, keyboard, monitor, mouse, printer, etc. as known in the art. Further, computer based device 12 includes automated telephonic survey software for enabling thereon for conducting a telephonic survey with the patient, conducting the telephone survey with the patient through the phone and real-time transmitting results obtained through the telephone survey to an attendant within the hospital. The survey software is equipped to generate real-time reports as seen in FIGS. 2-4. The survey software is also equipped to transmit a signal dispatch a predetermined attendant in response to one or more survey responses obtained through the survey.

It is conceived that the survey software can be controlled locally or remotely. It is envisioned that the remote server computer 16 can be connected to a plurality of computer based devices 12 which are located at one or more hospitals H. The remote server computer 16 can be equipped to with the survey software and equipped to provide a telephonic survey a for a particular hospital as well as send site specific signals to the video screen and/or printer signals thereto, wherein the video signals or printer signals can include survey report messages, attendant response messages, or other information for the particular site relating to the survey.

Accordingly, the system 10 can include one or more phones 14 operably disposed in one or more hospitals H, connected to the computer based device 12 and optionally the remote server computer 16. It is also envisioned that the phones 14 can be directly linked to a remote call center C to facilitate questions and answers and transactions for a user. Another embodiment can employ television 18 which can likewise be operably connected to the computer 12 to conduct the survey wherein the patient can look at the television and respond to displayed questions thereon using a TV remote control 20.

In one embodiment, the method includes the steps of (a) providing a phone at the hospital which is operably connected to a computer based device having survey software thereon for conducting a telephonic survey with the patient, (b) conducting the telephone survey with the patient through the phone and (c) real-time transmitting results obtained through the telephone survey to an attendant within the hospital. The method can also include the step of generating a real-time report. A further step can be dispatching a predetermined attendant in response to one or more survey responses. In another embodiment, the method includes the steps of (a) providing a television at the hospital which is operably connected to a computer based device having survey software thereon for conducting a television survey with the patient, (b) conducting the television survey with the patient through the television and (c) real-time transmitting results obtained through the television survey to an attendant within the hospital. The survey software can be equipped to prompt the patient through a series of topics and to indicate by predetermined numbers on the phone a level of satisfaction for the particular topic. For example, the patient can press 9 for poor, 5 for acceptable or 1 for good for each topic. Such topics can include medical care, nursing services, physician services, overall treatment, food, hospital amenities, phone service, television service, admission process, room condition, cost, cleaning and janitorial service, etc. The survey software can be equipped to send a signal, e.g., through a network, to a particular attendant upon the patient providing a particular response during a survey, such as dissatisfaction with the food whereby an electronic message can be sent to the hospital administrator as well as the cook to address the issue. Further, survey software can be equipped to gather data quantifying quality, cost, and assess performance characteristics of each, display the quality, cost and access performance characteristic simultaneously on a graph to indicate thereby strong and weak quality, cost and access performance characteristics, and identify the strong and weak quality, cost and access performance characteristics of each. Further, the software can prompt for other responses, such as whether the treatment is elective and non-elective treatment.

Again, it is also considered an aspect of the invention to provide for evaluating effectiveness of service of one or more hospitals. This evaluation includes gathering data, quantifying quality, cost, and assessing performance characteristics of each. This information can be displayed or produced in a manner currently known in the art to assess the quality, cost and assess performance characteristics and identify each for the hospital.

The present invention thus provides not only a feedback system with qualitative and quantitative aspects, but additionally provides a real-time response as a function of the system to enable each area to ascertain performance and continually improve satisfaction. Thus, the timing of the research is more likely to generate a better indication of satisfaction of the patient. A benefit of the invention is that corrective measures can be immediately taken as opposed to reconstructing the information of the personnel involved in treating the patient.

While the instant invention has been shown and described in what is considered to be a practical and preferred embodiments, it is recognized that departures may be made within the spirit and scope of this invention which is, therefore, not to be limited except as set forth in the claims hereinafter and within the doctrine of equivalents.

What is claimed is:

1. A method of conducting surveys within a hospital, which includes the steps of:
(a) providing one of a phone and a television at the hospital which is operably connected to a computer based device having survey software thereon for conducting one of a telephonic and a television survey with the patient;
(b) conducting one of said television and said telephone survey with a patient through one of said phone and television thereby gathering survey result data; and
(c) real-time transmitting said result data to an attendant within the hospital.

2. The method of conducting surveys within a hospital of claim 1, which further includes a step of generating a real-time report.

3. The method of conducting surveys within a hospital of claim 1, which further includes a step of dispatching a predetermined attendant in response to said survey result data.

4. The method of conducting surveys within a hospital of claim 1, wherein said survey software is equipped to prompt the patient through a series of topics and to indicate by predetermined numbers on one of said phone and said television a level of satisfaction for the particular topic.

5. The method of conducting surveys within a hospital of claim 4, wherein said topics include one of medical care, nursing services, physician services, overall treatment, food, hospital amenities, admission process, room condition, cost, cleaning and janitorial service.

6. The method of conducting surveys within a hospital of claim 1, wherein said survey software is equipped to send a signal to a predetermined attendant upon the patient providing a particular response during said survey.

7. The method of conducting surveys within a hospital of claim 1, wherein said survey software is equipped to send an electronic message to predetermined upon the patient providing a particular response during said survey.

8. The method of conducting surveys within a hospital of claim 1, wherein said survey software is equipped to gather data quantifying quality, cost, and assess performance characteristics of each, display the quality, cost and access performance characteristic simultaneously on a graph to indicate thereby strong and weak quality, cost and access performance characteristics, and identify the strong and weak quality, cost and access performance characteristics of each.

9. A system for conducting surveys within a hospital, which includes:
a phone operably disposed at the hospital; and
a computer based device having operably connected to said phone having survey software thereon for conducting a telephonic survey with the patient to gather survey result data and having means for real-time transmitting said survey result data to an attendant within the hospital.

10. The system for conducting surveys within a hospital of claim 9, which further includes a television operably disposed at the hospital which is operably connected to said computer based device, said computer based device having survey software thereon for conducting a television survey with the patient to gather survey result data and having means for real-time transmitting said survey result data to an attendant within the hospital.

11. The system for conducting surveys within a hospital of claim 9, wherein said survey software is equipped to generate a real-time report.

12. The system for conducting surveys within a hospital of claim 9, wherein said survey software is equipped to send a dispatch message to a predetermined attendant in response to said survey result data.

13. The system for conducting surveys within a hospital of claim 9, wherein said survey software is equipped to prompt the patient through a series of topics and to indicate by predetermined numbers on the phone a level of satisfaction for the particular topic.

14. The system for conducting surveys within a hospital of claim 12, wherein said topics include one of medical care, nursing services, physician services, overall treatment, food, hospital amenities, admission process, room condition, cost, cleaning and janitorial service.

15. The system for conducting surveys within a hospital of claim 9, wherein said survey software is equipped to send a signal to a predetermined attendant upon the patient providing a particular response during said survey.

16. The system for conducting surveys within a hospital of claim 9, wherein said survey software is equipped to send an electronic message to predetermined upon the patient providing a particular response during said survey.

17. The system for conducting surveys within a hospital of claim 9, wherein said survey software is equipped to gather data quantifying quality, cost, and assess performance characteristics of each, display the quality, cost and access performance characteristic simultaneously on a graph to indicate thereby strong and weak quality, cost and access performance characteristics, and identify the strong and weak quality, cost and access performance characteristics of each.

18. A system for conducting surveys within a hospital, which includes:
a television operably disposed at the hospital; and
a computer based device having operably connected to said television having survey software thereon for conducting a television survey with the patient to gather survey result data and having means for real-time transmitting said survey result data to an attendant within the hospital.

19. The system for conducting surveys within a hospital of claim 18, wherein said survey software is equipped to generate a real-time report.

20. The system for conducting surveys within a hospital of claim 18, wherein said survey software is equipped to send a dispatch message to a predetermined attendant in response to said survey result data.

21. The system for conducting surveys within a hospital of claim 18, wherein said survey software is equipped to prompt the patient through a series of topics and to indicate by predetermined numbers on the phone a level of satisfaction for the particular topic.

22. The system for conducting surveys within a hospital of claim 21, wherein said topics include one of medical care, nursing services, physician services, overall treatment, food, hospital amenities, admission process, room condition, cost, cleaning and janitorial service.

23. The system for conducting surveys within a hospital of claim 18, wherein said survey software is equipped to send a signal to a predetermined attendant upon the patient providing a particular response during said survey.

24. The system for conducting surveys within a hospital of claim 18, wherein said survey software is equipped to send an electronic message to predetermined upon the patient providing a particular response during said survey.

25. The system for conducting surveys within a hospital of claim 18, wherein said survey software is equipped to gather data quantifying quality, cost, and assess performance characteristics of each, display the quality, cost and access performance characteristic simultaneously on a graph to indicate thereby strong and weak quality, cost and access performance characteristics, and identify the strong and weak quality, cost and access performance characteristics of each.
